(19) United States
(12) Patent Application Publication
(10) Pub. No.: US 2010/0279553 A1
(43) Pub. Date: Nov. 4, 2010

(54) Multiconductor Jack and Multiconductor Plug

(75) Inventor: Eiichiro Izumi, Ehime-ken (JP)

Correspondence Address: Gerald T Peters;JTT Patent Services, LLC, 23-21 Yayoigaoka-cho, Takatsuki-shi, Osaka-fu, 569-1021, JP

(73) Assignee: EX Company Limited, Matsuyama-shi, Ehime-ken (JP)

(21) Appl. No.: 12/746,519

(22) PCT Filed: Dec. 6, 2007
(86) PCT No.: PCT/JP2007/001359

§ 371 Date: Jun. 5, 2010

(51) Int. Cl. H01R 24/04

(52) U.S. Cl. 439/669; 439/668

(57) ABSTRACT

Problem It is an object to provide a multiconductor jack and a multiconductor plug having an increased number of electrodes while ensuring practicality as well as compatibility with conventional multiconductor plugs.

Solution Means A five-conductor plug associated with the present embodiment comprises first through fifth electrodes (11a through 11e) made of electrically conductive metal(s), and insulating collars (12a through 12d) made of insulating material(s) for achieving isolation between the respective electrodes (11). Outside diameter of fifth electrode (11e) at rod portion (14) is large compared with other electrodes (11a through 11d). The five-conductor jack (20) comprises an insulating casing (21) made of synthetic resin, first through fifth electrically conductive terminals (23a through 23e), switching terminals (24a, 24b), and a thrust member (stopper) (25) secured to the fourth electrically conductive terminal (23d) and located in the region of an opening that is an inlet for a jack. Thrust member (25) is acted on by a restoring force that causes it to protrude into the opening of casing (21), and when protruding, to constrain said opening to a small diameter.

### TECHNICAL FIELD

The present invention relates to a jack and a plug serving as electric connectors for carrying out electrically conductive connection, and more particularly, to a multiconductor jack and a multiconductor plug.

### BACKGROUND ART

Many multiconductor plugs having three or four electrodes have conventionally been provided as plugs for use with portable music players, for example. However, because portable music players have in recent years come to be equipped with a great many functions, and also because of the need to provide multifunctional remote control capability and so forth, there is demand for further increase in the number of electrodes.

To meet such demand, Patent References Nos. 1 through 4, below, disclose multiconductor plugs and multiconductor jacks having five or more electrodes.

### Patent Reference No. 1: Japanese Utility Model Registration No. 2545747

### Patent Reference No. 2: Japanese Registered Utility Model No. 3078619

### Patent Reference No. 3: Japanese Patent No. 3569658

### Patent Reference No. 4: Japanese Patent Application Publication Kokai No. 2002-134237

The multiconductor plugs disclosed in Patent Reference Nos. 1 through 4 achieve increased number of electrodes by more finely subdividing the surface of the post in the axial direction to increase the number of electrodes, providing an electrode at the tip of the post, or providing electrodes on the interior and exterior surfaces of the cylindrical portion (plug cover) disposed peripherally about the base portion of the post.

### DISCLOSURE OF INVENTION

### Problems to be Solved by the Invention

However, employing the method of more finely subdividing the post in the axial direction to increase the number of electrodes causes insulating collar and/or electrode thickness to become thinner as the number of electrodes is increased, making manufacture difficult. Furthermore, because the central electrode (tip), or rod, is also made thinner, it becomes impossible to ensure adequate plug strength. In particular, in the case of a φ 2.5 plug, because the post (rod) portion is already thin even before increasing electrode number, it has been difficult to achieve five electrodes in the rod region without compromising practicality.

Furthermore, when the plug cover at the base portion of the post is employed as electrode(s), this becomes a multiconductor plug, different in shape from conventional two-conductor plugs and three-conductor plugs, as defined by the standards of the Japan Electronics and Information Technology Industries Association. As multiconductor jacks used in combination with multiconductor plugs having such plug cover electrode(s) are frequently incapable of being connected to multiconductor plugs defined by existing standards, there is the problem that multiconductor plugs and multiconductor jacks that have been manufactured in-house may be incompatible in structure with conventional multiconductor plugs.

The present invention has been devised to solve the above problems, it being an object of the present invention to provide a multiconductor jack and a multiconductor plug having an increased number of electrodes while ensuring practicality as well as compatibility with conventional multiconductor plugs.

### Means for Solving the Problems

To solve the above problems, a multiconductor plug associated with the present invention has a rod portion exposing in order at one or more surfaces thereof a plurality of mutually insulated electrodes, the multiconductor plug being characterized in that an electrode nearest a base at the rod portion is a large-diameter electrode having a diameter that is larger in diameter than diameter(s) of other electrode(s).

Furthermore, a multiconductor jack associated with the present invention is for connection to a multiconductor plug having a rod portion exposing in order at one or more surfaces thereof a plurality of mutually insulated electrodes, the multiconductor jack being characterized in that it comprises a casing forming a plug-receiving space capable of receiving the rod portion of the multiconductor plug, and an opening that is an inlet to the plug-receiving space; a plurality of electrically conductive terminals arranged so as to face the plug-receiving space in such manner as to permit electrically conductive contact with the respective electrodes during connection with the multiconductor plug; and a thrust member for constraining the opening of the casing to a small diameter by protruding into said opening.

### EFFECT OF THE INVENTION

Multiconductor jacks and multiconductor plugs associated with the present invention permit increased number of electrodes while ensuring practicality as well as compatibility with conventional multiconductor plugs.

### BEST MODES FOR CARRYING OUT THE INVENTION

Embodiments of the present invention will be described in detail below with reference to the drawings. Description will be given in terms of a five-conductor subminiature straight plug (φ 2.5 mm) serving as an example of a multiconductor plug associated with the present embodiment, and in terms of a five-conductor jack for connection with this five-conductor subminiature straight plug and serving as an example of a multiconductor jack associated therewith.

First, referring to FIGS. 1 and 2, the configuration of a multiconductor plug associated with the present embodiment will be described. FIG. 1 is a perspective view of a five-conductor plug associated with the present embodiment, and FIG. 2 is a sectional perspective view of the five-conductor plug associated with the present embodiment.

As shown in FIGS. 1 and 2, a five-conductor plug 10 comprises first through fifth electrodes 11a through 11e made of electrically conductive metal(s), and insulating collars 12a through 12d made of insulating material(s) for achieving isolation between the respective electrodes 11. Furthermore, these electrodes 11 and insulating collars 12 form a rod-shaped rod portion 14, this being the portion that is inserted in the jack; a flange portion (grip) 15 that is disposed at the base of the rod portion 14 and protrudes outward in flange-like fashion; and a lead portion 16 at which wiring connects to the respective electrodes 11.

A rod-shaped first electrode (tip) 11a is located centrally within the rod portion 14, being exposed at the surface of the rod portion 14 at the tip of first electrode 11a, this exposed portion making electrically conductive contact with a terminal of the jack. A cylindrical second electrode (ring) 11b is disposed exterior to the first electrode 11a, with a first insulating collar 12a serving as insulating layer being interposed therebetween. Similarly, disposed in order as one proceeds toward the exterior of the rod portion 14 there are: a second insulating collar 12b, a third electrode (ring) 11c, a third insulating collar 12c, a fourth electrode (ring) 11d, a fourth insulating collar 12d, and a fifth electrode (ring) 11e.

Thus, electrodes 11 and insulating collars 12, disposed in order in coaxial fashion, expose in annular fashion at the surfaces thereof in order as one proceeds from the tip of the rod portion 14 toward the flange portion 15: the first electrode 11a, the first insulating collar 12a, the second electrode 11b, the second insulating collar 12b, the third electrode 11c, the third insulating collar 12c, the fourth electrode 11d, the fourth insulating collar 12d, and the fifth electrode 11e. The exposed surfaces of these respective electrodes 11 at the rod portion 14 make electrically conductive contact with electrically conductive terminals of the five-conductor jack, described below.

Furthermore, at flange portion 15, a portion of the fifth electrode 11e protrudes in annular fashion to form a flanged part. Side surface 15a on the rod portion 14 side of the flange portion 15 is a reference surface, serving as reference when defining locations at which the respective electrodes 11 of the rod portion 14 are to be exposed.

At the lead portion 16 as well, exposed at the surfaces thereof in order as one proceeds from the flange portion 15 toward the tip of the lead portion 16 there are: the fifth electrode 11e, the fourth insulating collar 12d, the fourth electrode 11d, the third insulating collar 12c, the third electrode 11c, the second insulating collar 12b, the second electrode 11b, the first insulating collar 12a, and the first electrode 11a. Also, at the lead portion 16, lead wires are connected to exposed locations of respective electrodes 11.

Here, at a region adjacent to the flange portion 15 and nearest the base (i.e., nearest the flange portion 15) of the five-conductor plug 10 associated with the present embodiment, fifth electrode 11e, where it is exposed at the surface of the rod portion 14, has an outside diameter at the rod portion 14 that is larger than at the other electrodes 11a through 11d. While the outside diameter of the other electrodes 11a through 11d at the rod portion 14 is φ 2.5 mm, the outside diameter of the fifth electrode 11e is φ 3.0 mm, the outer surface of the fifth electrode 11e extending outward 0.25 mm beyond the outer surfaces of the first through fourth electrodes 11a through 11d.

Moreover, formed toward the tip portion of the surface at which the fifth electrode 11e is exposed on the rod portion 14 is a guiding tapered portion 11e-1 at which diameter gradually increases as one proceeds from the tip side to the base side so as to smoothly join the outer surface of the fifth electrode 11e, which is φ 3.0 mm, to the outer surface of the fourth insulating collar 12d, which is φ 2.5 mm. Of course, the tapered portion, which smoothly connects the outer surface of the rod portion 14 at the fifth electrode 11e and the outer surface of the fourth electrode 11d, these having mutually different outside diameters, need not be formed at the fifth electrode 11e but may instead be formed at the fourth electrode 11d or may be formed at the fourth insulating collar 12d.

By thus causing the fifth electrode 11e to extend outward beyond other surfaces, it is possible to ensure thicknesses similar to those of electrodes and insulating collars in four-conductor plugs, there being almost no need to reduce thickness at the first through fourth electrodes 11a through 11d, despite addition of the fifth electrode. The present embodiment therefore makes it possible to ensure adequate strength in the context of a structure capable of withstanding the test of practicality, without making manufacturing overly difficult, despite increase in the number of electrodes.

Next, referring to FIGS. 3 and 4, the configuration of the multiconductor jack associated with the present embodiment will be described. FIG. 3 is a perspective view of a five-conductor jack associated with the present embodiment, and FIG. 4 is a perspective view, with hidden lines partially visible, of the five-conductor jack associated with the present embodiment.

As shown in FIGS. 3 and 4, a five-conductor jack 20 comprises an insulating casing 21 made of synthetic resin; first through fifth electrically conductive terminals 23a through 23e disposed in prescribed places at the casing 21 so as to make electrically conductive contact with the respective electrodes 11 of the multiconductor plug 10; switching terminals 24a, 24b that come in contact with electrodes 11 so as to detect insertion of the plug; and a thrust member (stopper) 25 that is attached to the fourth electrically conductive terminal 23d and that is located in the region of an opening which is an inlet for the jack.

Formed within the casing 21 is a plug-receiving space for receiving the rod portion 14 of the multiconductor plug 10; and formed at one of the side surfaces of the casing 21 there is also an opening that is an inlet for the plug to the plug-receiving space, the rod portion 14 of the multiconductor plug 10 being inserted into the casing 21 from this inlet. The inside diameter of the rim region 21a forming an opening in the casing 21 is φ 3.1 mm, being formed 0.1 mm larger than φ 3.0 mm, so as to permit insertion of the portion corresponding to the large-diameter fifth electrode 11e of the five-conductor plug 10 associated with the present embodiment.

Electrically conductive terminals 23 and switching terminals 24 are disposed so that portions thereof that come in contact with the electrodes 11 are made to face the plug-receiving space. As shown in FIG. 4, disposed at one side of the plug-receiving space, there are, in order as one proceeds from the opening toward the interior: fifth electrically conductive terminal 23e, switching terminal 24b, and second electrically conductive terminal 23b. Furthermore, disposed at the other side thereof, there are, in order as one proceeds from the opening toward the interior: fourth electrically conductive terminal 23d, third electrically conductive terminal 23c, switching terminal 24a, and first electrically conductive terminal 23a.

Furthermore, electrically conductive terminals 23 and switching terminals 24 are made of electrically conductive metal, the respective electrically conductive terminals 23 and switching terminals 24 being formed in such shapes as will cause them to press against the respective electrodes 11 due to elastic forces when the plug and the jack are connected to each other.

Specifically, when the multiconductor plug 10 is not inserted therein, the contacting portions of the electrically conductive terminals 23a through 23e and the switching terminals 24a, 24b are disposed such that they protrude somewhat into the space that will receive the rod portion 14 of the multiconductor plug 10. Moreover, when the multiconductor plug 10 is inserted therein, the contacting portions of the electrically conductive terminals 23a through 23e and the switching terminals 24a, 24b are pushed back by the electrodes 11a through 11e, deformation of the respective terminals 23, 24 generating elastic forces in directions perpendicular to the axis and causing the contacting portions to press against the respective electrodes 11a through 11e. When the contacting portions of the electrically conductive terminals 23 and the switching terminals 24 are made to press against the electrodes 11 of the plug in this manner, electrically conductive contact can be maintained satisfactorily even in the event that external forces are applied to the plug and/or jack.

Furthermore, because the present embodiment is constituted such that the outside diameter of the fifth electrode 11e is larger, by 0.25 mm as measured at the radius, than the outside diameter(s) of the other electrodes 11a through 11d, the fifth electrically conductive terminal 23e that comes in electrically conductive contact with the fifth electrode 11e is such that the contacting portion thereof is disposed 0.25 mm outward from the contacting portions of the other electrically conductive terminals 23a through 23d.

Switching terminals 24a, 24b are terminals for detecting when the rod portion 14 of the multiconductor plug 10 has been inserted within the plug-receiving space of the five-conductor jack 20. For example, these might be used to carry out control of the sort whereby when switching terminal 24a comes in contact with electrode(s) 11 the L speaker at the equipment (device) is terminated, and such that when switching terminal 24b comes in contact with electrode(s) 11 the R speaker at the equipment is terminated.

Next, constitution of a thrust member 25 is described in detail with reference to the drawings. FIG. 5 is an enlarged perspective view showing the fourth electrically conductive terminal and thrust member associated with the present embodiment, FIG. 5(a) showing the fourth electrically conductive terminal 23d and the thrust member 25 as viewed from inside (the plug-receiving space side) the five-conductor jack 20, and FIG. 5(b) showing the fourth electrically conductive terminal 23d and the thrust member 25 as viewed from outside the five-conductor jack 20.

The thrust member 25 is manufactured from molded resin. While this may of course be made from other material(s), because in the present embodiment the thrust member 25, which is secured to and disposed at the fourth electrically conductive terminal 23d, comes in contact with the fifth electrode 11e when the plug and the jack are connected, it is necessary that the thrust member 25 and the fourth electrically conductive terminal 23d be insulated.

As shown in FIG. 5, the thrust member 25 is secured to the tip of the fourth electrically conductive terminal 23d. The fourth electrically conductive terminal 23d is such that a securing portion 23d-1 is secured to the casing 21, and such that electrically conductive sheet metal extends toward the tip by way of flexure regions 23d-2, 23d-3, 23d-4. At these three flexure regions 23d-2, 23d-3, 23d-4, the fourth electrically conductive terminal 23d is capable of experiencing a large amount of elastic deformation, elastic deformation resulting in generation of elastic forces.

The thrust member 25 is disposed such that, at the region of the opening in the casing 21, the side surface 25b at the inlet side thereof is located in a plane withdrawn 0.1 mm toward the inside (interior) from the end of the casing 21 at which the opening is located. Furthermore, the thrust member 25 is disposed so as to protrude into the opening of the casing 21, the inside surface 25a thereof constraining the opening of the casing 21 to an even smaller diameter. Specifically, the diameter at the arc on the inside surface 25a of the thrust member 25 is 2.6 mm, so that with the thrust member 25 protruding into the region of the opening, only a post that is smaller in diameter than 2.6 mm will be able to pass through the opening that is constrained in this way by the thrust member 25.

Of course, these sizes are not limited to the sizes given above, it being possible to appropriately vary sizes over ranges such as will permit similar effect. For example, the thrust member 25 may be such that the side surface 25b at the inlet side thereof and the end of the casing 21 at which the opening is located are coplanar. Furthermore, it is sufficient that the thrust member 25 be of such size and be disposed such as to permit the φ 2.5 mm rod portion 14 to pass through the opening when the thrust member 25 protrudes into the region of the opening.

Moreover, the thrust member 25, being secured to the tip of the fourth electrically conductive terminal 23d which is capable of a large amount of deformation at the flexure regions 23d-2, 23d-3, 23d-4, is constituted so as to move very little in the axial direction of the multiconductor jack 20 (multiconductor plug 10) but so as to be easily movable in directions perpendicular to the axial direction. Accordingly, the thrust member 25, when pressed upon from the inside, is pushed back and made to withdraw toward the outside of the opening, and when no longer pressed upon, is due to action of elastic forces made to return to a position at which it protrudes into the region of the opening.

Electrically conductive terminal(s) at the jack are ordinarily disposed at prescribed location(s) such as will cause electrically conductive terminal(s) of the jack and corresponding electrode(s) of the plug to come into electrically conductive contact when the jack and the plug are connected, provided that the reference surface of the flange portion of the plug abuts the surface at the end of the jack at which the opening is located. However, in the present embodiment, so that the φ 3.0 mm large-diameter fifth electrode 11e can be received within the jack, the diameter of the opening of the casing 21 is formed so as to be 3.1 mm, which is larger than 3.0 mm. For this reason, if one were to attempt to connect a conventional φ 2.5 subminiature straight plug, i.e., a subminiature straight plug having a flange portion smaller than 3.1 mm, to the five-conductor jack 20, the flange portion would pass beyond the rim region 21a of the casing 21 and into the plug-receiving space, and not only would the corresponding electrode(s) 11 and electrically conductive terminal(s) 23 become unable to make electrically conductive contact but the five-conductor plug 10 and/or the five-conductor jack 20 could become damaged.

To address this, because a thrust member 25 for constraining the opening of the casing 21 of the five-conductor jack 20 to an even smaller diameter is provided in the present embodiment, even where the plug has a flange portion that is narrower than φ 3.1, the reference surface of the flange portion will abut the thrust member 25 and prevent entry beyond this point, thus making it possible to ensure electrically conductive contact between the electrode(s) 11 and the electrically conductive terminal(s) 23.

In addition, when the five-conductor plug 10 associated with the present embodiment is inserted therein, the rod portion 14 can be inserted within the jack in such manner that the thrust member 25 remains where it is and is not made to withdraw as far as the φ 2.5 mm first through fourth electrodes 11a through 11d. As the fifth electrode 11e approaches the region of the opening formed by the rim region 21a, because the diameter of the rod portion 14 grows gradually larger in the region of the tapered portion 11e-1, the surface of the tapered portion 11e-1 comes into contact with the thrust member 25.

After these come into contact, if the five-conductor plug 10 continues to be inserted therein, as the diameter of the guiding tapered portion 11e-1 grows larger, the thrust member 25 is pressed upon and is gradually made to withdraw outward. In addition, when the reference surface 15a of the five-conductor plug 10 comes in contact with the surface outside the rim region 21a of the casing 21 at the end thereof at which the opening is located, connection of the five-conductor plug 10 and the five-conductor jack 20 is complete. At this time, the thrust member 25 is pressed upon by the surface of the φ 3.0 mm portion of the fifth electrode 11e and is made to withdraw.

Moreover, because flexure region 23d-4 intervenes between the thrust member 25 and the contacting portion 23d-5, even though the thrust member 25 may be made to withdraw, deforming the fourth electrode 23d, there will nonetheless be minimal deformation at the location of the contacting portion 23d-5, and electrically conductive contact between the fourth electrically conductive terminal 23d and the fourth electrode 11d will be unaffected thereby.

Next, the situation that exists when the five-conductor plug 10 and the five-conductor jack 20 are connected will be described with reference to FIG. 6 and FIG. 7. FIG. 6 is a sectional view showing the situation that exists when a five-conductor plug and a five-conductor jack associated with the present embodiment are connected; and FIG. 7 is a drawing showing the situation that exists when the five-conductor plug and the five-conductor jack associated with the present embodiment are connected, as viewed from below. At FIG. 7, to improve clarity of presentation, note that only the five-conductor jack 10, electrically conductive terminals 23, switching terminals 24, and thrust member 25 are shown.

As shown in FIG. 6 and FIG. 7, when the five-conductor plug 10 and the five-conductor jack 20 are connected, the first electrode 11a is in contact with the first electrically conductive terminal 23a, the second electrode 11b is in contact with the second electrically conductive terminal 23b, the third electrode 11c is in contact with the third electrically conductive terminal 23c, the fourth electrode 11d is in contact with the fourth electrically conductive terminal 23d, and the fifth electrode 11e is in contact with the fifth electrically conductive terminal 23e.

Furthermore, because the outside diameter at the rod portion 14 of the fifth electrode 11e of the five-conductor plug 10 is large, being φ 3.0 mm, the thrust member 25 is pressed upon by the rod portion 14 and is made to withdraw outward as shown in FIG. 7. Moreover, the reference surface 15a of the flange portion 15 is in contact with the surface at the rim region 21a of the casing 21 at the end thereof at which the opening is located.

Next described with reference to FIG. 8 is a case in which a conventional φ 2.5 subminiature straight plug 50, having small diameter at the flange portion thereof, is inserted into the five-conductor jack 20. FIG. 8 is a drawing showing the situation that exists when a five-conductor jack associated with the present embodiment and a conventional three-conductor subminiature straight plug are connected, as viewed from below.

As shown in FIG. 8, when the three-conductor plug 50 and the five-conductor jack 20 are connected, the first electrode 51a is in contact with the first electrically conductive terminal 23a, the second electrode 51b is in contact with the second electrically conductive terminal 23b, and the third electrode 51c is in contact with the third through fifth electrically conductive terminals 23c through 23e.

Here, because the diameter of the third electrode 51c nearest the base at the rod portion is, like the other electrodes 51a, 51b, φ 2.5 mm, the rod portion of the three-conductor plug 50, when connected, enters the plug-receiving space unhindered from the rim region of the multiconductor jack 20. Furthermore, the thrust member 25 is not pressed upon by the rod portion of the three-conductor plug 50 but, being undeflected thereby, continues to protrude into the region of the opening of the jack.

In addition, even though the flange portion 50 of the three-conductor plug 50 may come as far as the region of the opening, because the outside diameter of the flange portion 50 is 3.0 mm, which is smaller than the 3.1 mm inside diameter of the rim region 21a of the casing 21, the flange portion may enter the region of the opening, but because the outside diameter of the flange portion 50 is larger than the φ 2.6 mm diameter of the opening as constrained by the thrust member 25, the reference surface 55a will come in contact with the surface at the end of the thrust member 25 as shown in FIG. 8.

Thus, when the reference surface 55a of the three-conductor plug 50 comes in contact with the thrust member 25, ingress of the plug into the jack interior is stopped and connection is made. Accordingly, in the present embodiment, presence of the thrust member 25 makes it possible to stop even a conventional multiconductor plug having a narrow flange portion from going too far into the jack interior.

Above, the present embodiment has been described in detail, the fact that the outside diameter of an electrode nearest the base at the rod portion is made large making it possible, in the present embodiment, to increase the number of electrodes while leaving thicknesses of other electrode(s) and/or insulating resin(s) largely unaffected. In particular, taking the case of a narrow φ 2.5 mm multiconductor jack, increasing the number of electrodes at the base part to five resulted in reduced thickness at electrodes and/or insulating collars, making mass production impossible in practice even if pilot production might have been possible. In contrast, the five-conductor plug associated with the present embodiment makes it possible to provide a five-conductor plug that has five electrodes at the base part and that is more than capable of being mass-produced.

Furthermore, in the present embodiment, because the base of the rod portion of the five-conductor plug is broadened, it is necessary to widen the rim region of the five-conductor jack. For this reason, if one were to attempt to connect a conventional multiconductor plug to this five-conductor jack, with a conventional multiconductor plug having a narrow flange portion there would be the problem that the flange portion would pass beyond the widened rim region and would go too far into the jack interior.

To address this, provision of a thrust member that protrudes into the rim region of the five-conductor jack and constrains the opening to a small diameter, and that is made to withdraw outward when pushed on from the inside, makes it possible in the present embodiment to prevent conventional multiconductor plugs having narrow flange portions from going too far into the interior.

Moreover, a multiconductor plug in accordance with the present embodiment is such that an outer circumferential surface of a large-diameter electrode which has large diameter and is disposed nearest a base, and an outer circumferential surface of an electrode adjacent on a tip side of this large-diameter electrode, are smoothly joined by a guiding tapered portion. In accompaniment to insertion of the plug into the jack, this tapered portion presses outward on the thrust member from the inside, causing the thrust member to withdraw outward therefrom.

While embodiments of the present invention have been described above in detail, it goes without saying that modes of carrying out the present invention are not limited to the foregoing embodiments, a great many variations being possible without departing from the gist of the present invention. For example, whereas in the present embodiment a rotary connector was made up of a five-conductor plug and a five-conductor jack, it goes without saying that the number of electrodes at the plug and the jack may be varied as appropriate

Furthermore, whereas the present embodiment was described in terms of the example of a φ 2.5 mm multiconductor plug and multiconductor jack, it goes without saying that this may be applied to plugs and jacks of other sizes; such as, for example, φ 3.5 mm, φ 6.3 mm, and so forth.

Furthermore, whereas in the present embodiment the electrode nearest the base at the rod portion was made broader, by 0.5 mm as measured at the diameter, than the other electrodes, it is possible to increase the number of electrodes without compromising thickness at other electrode(s) and/or insulating collar(s) if this is made broader by 0.2 mm or more (or more preferably, 0.4 mm or more) as measured at the diameter.

Furthermore, whereas a thrust member was provided at only one location in the present embodiment so as to make the multiconductor jack thin and compact, two thrust members may be provided so as to be present at either side, or even more thrust members may be provided. Furthermore, the size of the thrust member(s) may also be varied as appropriate. Furthermore, whereas the thrust member was secured to the fourth electrically conductive terminal in the present embodiment so as to utilize elastic forces from the fourth electrically conductive terminal, the thrust member may be secured to other electrically conductive terminal(s), e.g., the fifth electrically conductive terminal, or the thrust member may be constituted such that it itself possesses elastic forces and such that it is secured by itself to the casing of the jack.

Furthermore, whereas elastic forces were responsible in the present embodiment for causing the thrust member to be acted on by a restoring force that caused it to protrude into the region of an opening in the casing, a constitution is also possible in which thrust member(s) is/are manually made to withdraw. That is, in such a constitution, the thrust member would be made capable of sliding between a position at which it protrudes into the region of the opening in the case and constrains the diameter of the opening, and a position at which it is withdrawn from the region of the opening. When connecting a plug having a narrow flange portion such as would pass through the region of the opening in the case, the user might manually cause the thrust member to protrude into the region of the opening and constrain the opening to a small diameter.

### BRIEF DESCRIPTION OF THE DRAWINGS

FIG. 1 is a perspective view of a five-conductor plug associated with the present embodiment.

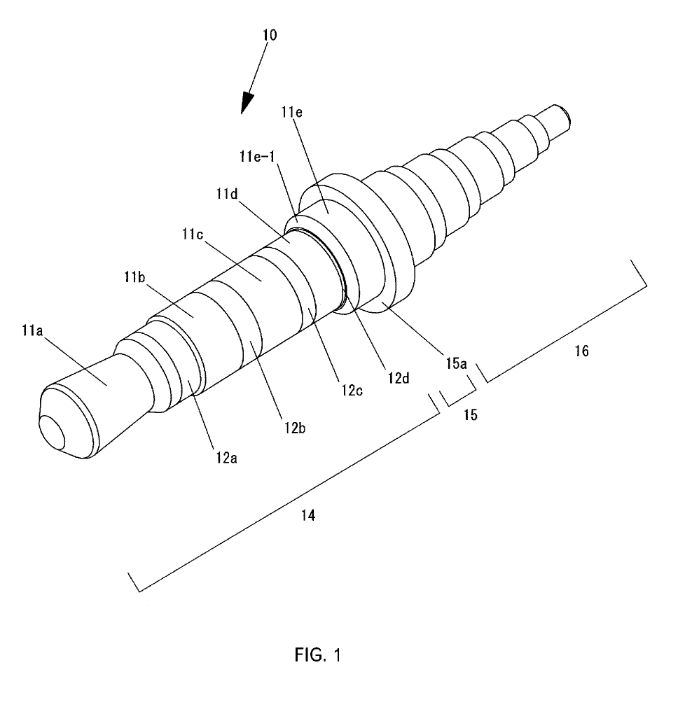

FIG. 2 is a sectional perspective view of the five-conductor plug associated with the present embodiment.

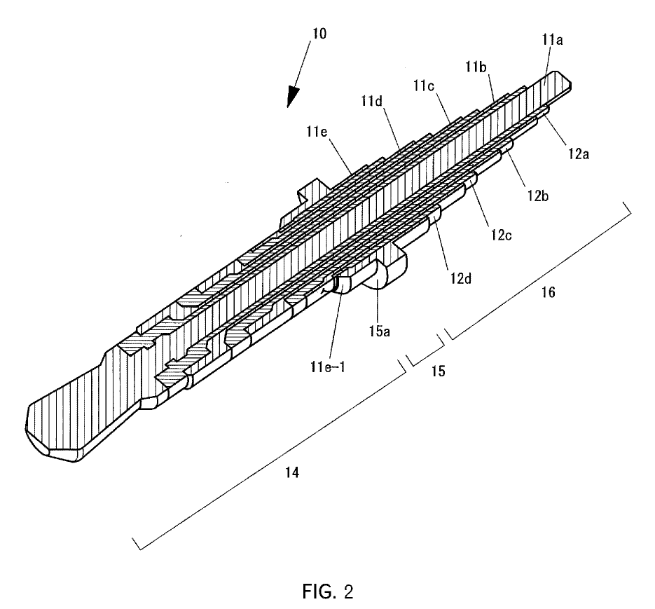

FIG. 3 is a perspective view of a five-conductor jack associated with the present embodiment.

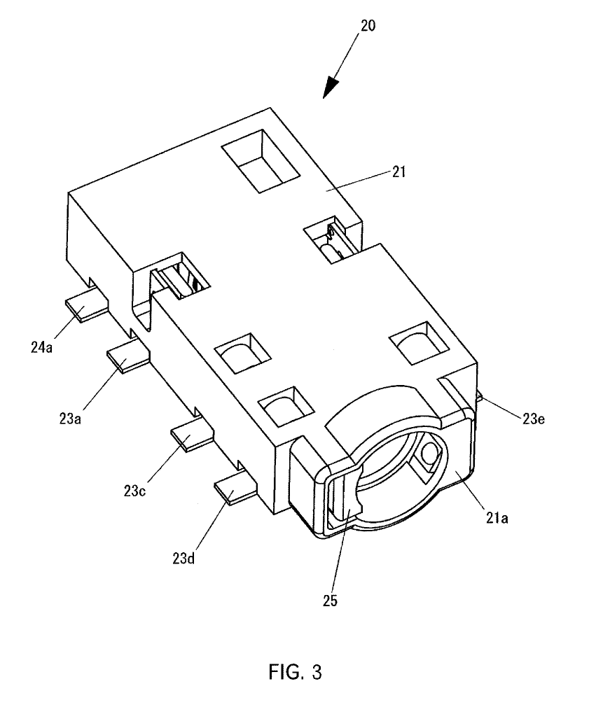

FIG. 4 is a perspective view, with hidden lines partially visible, of the five-conductor jack associated with the present embodiment.

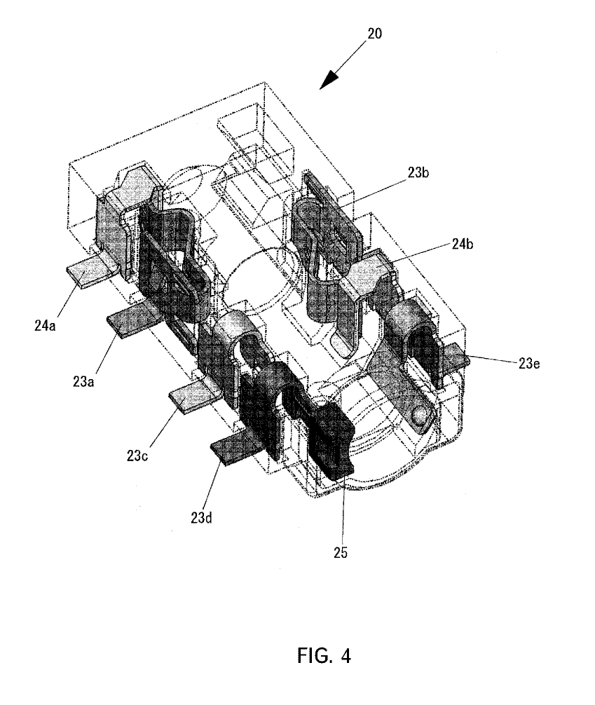

FIG. 5 an enlarged perspective view showing the fourth electrically conductive terminal and thrust member associated with the present embodiment.

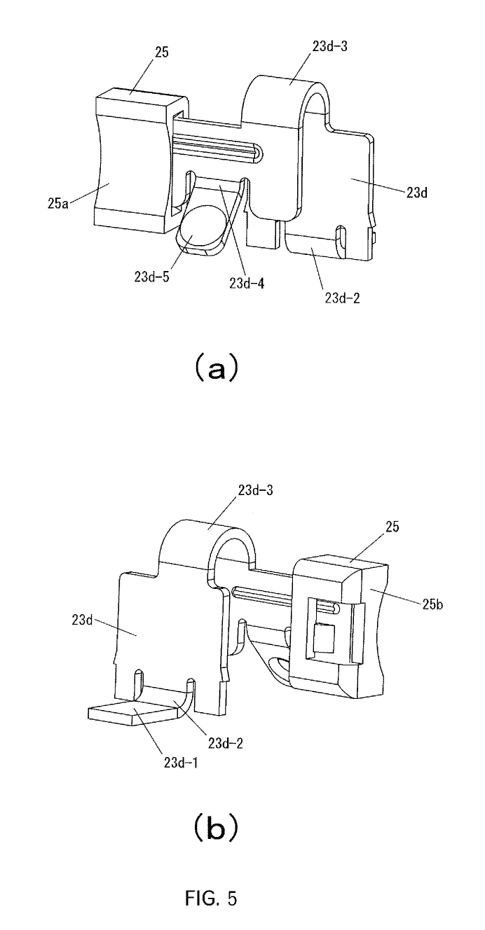

FIG. 6 is a sectional view showing the situation that exists when a five-conductor plug and a five-conductor jack associated with the present embodiment are connected.

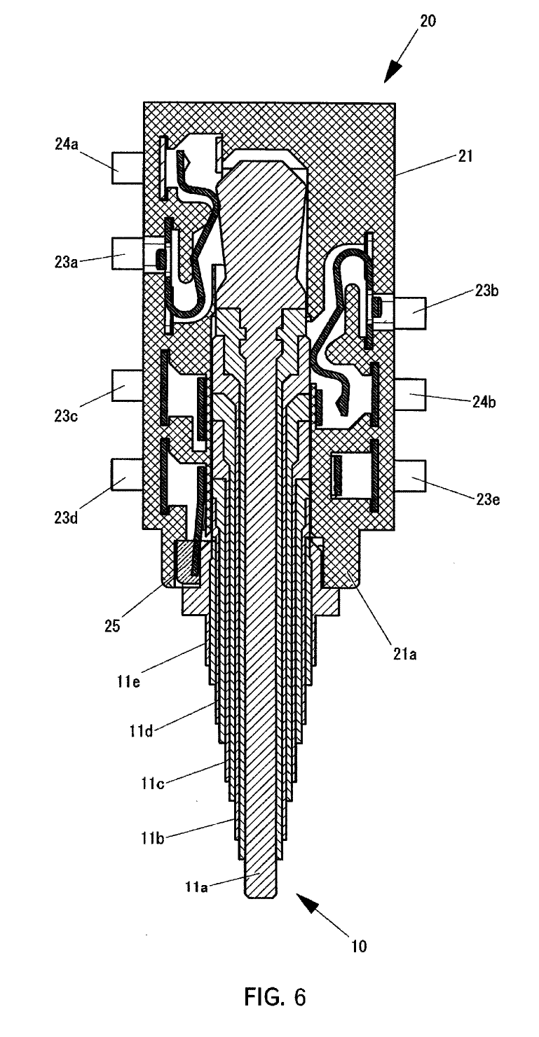

FIG. 7 is a drawing showing the situation that exists when the five-conductor plug and the five-conductor jack associated with the present embodiment are connected, as viewed from below.

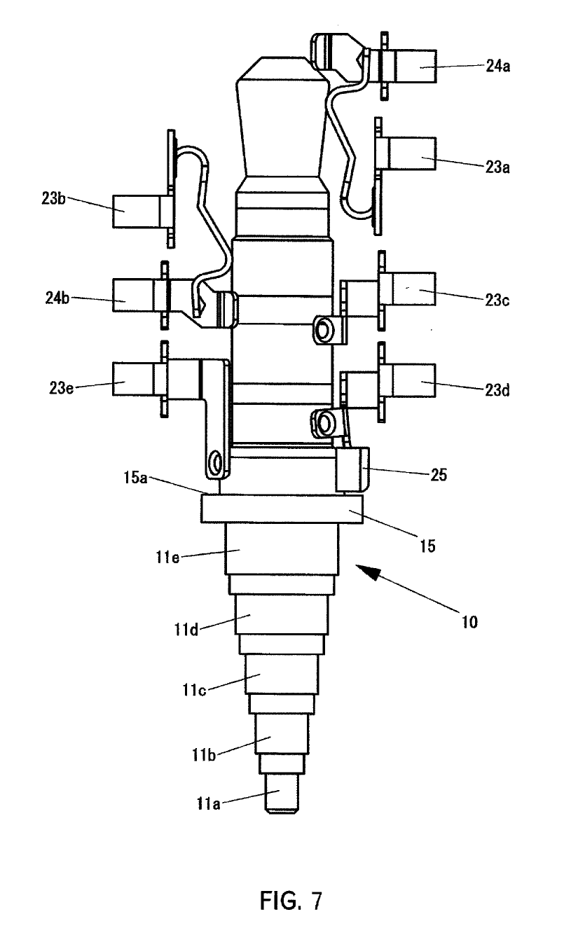

FIG. 8 is a drawing showing the situation that exists when a five-conductor jack associated with the present embodiment and a conventional three-conductor subminiature straight plug are connected, as viewed from below.

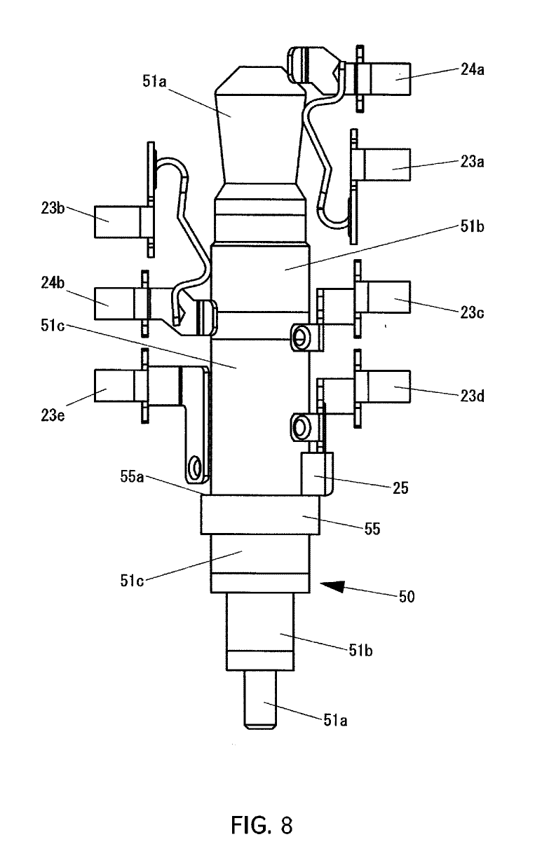

### EXPLANATION OF REFERENCE NUMERALS

10 Five-conductor plug
11 Electrodes
12 Insulating collars
14 Rod portion
15 Flange portion
16 Lead portion
20 Five-conductor jack
21 Casing
23 Electrically conductive terminals
24 Switching terminals
25 Thrust member (stopper)

1. A multiconductor plug having a rod portion exposing in order at one or more surfaces thereof a plurality of mutually insulated electrodes, the multiconductor plug being characterized in that
an electrode nearest a base at the rod portion is a large-diameter electrode having a diameter that is larger in diameter than the diameters of the other electrodes.

2. A multiconductor plug according to claim 1 characterized in that an outer circumferential surface of an electrode adjacent on a tip side of the large-diameter electrode, and an outer circumferential surface of the large-diameter electrode, these being of mutually different diameters, are joined by a guiding tapered portion.

3. A multiconductor jack for connection to a multiconductor plug having a rod portion exposing in order at one or more surfaces thereof a plurality of mutually insulated electrodes, the multiconductor jack being characterized in that it comprises:
a casing forming a plug-receiving space capable of receiving the rod portion of the multiconductor plug, and an opening that is an inlet to the plug-receiving space;
a plurality of electrically conductive terminals arranged so as to face the plug-receiving space in such manner as to permit electrically conductive contact with the respective electrodes during connection with the multiconductor plug; and
a thrust member for constraining the opening of the casing to a small diameter by protruding into said opening.

4. A multiconductor jack according to claim 3 characterized in that the thrust member is constituted such that it can be moved between the protruding position and a position withdrawn from said protruding position.

5. A multiconductor jack according to claim 4 characterized in that the thrust member is constituted so as to be acted on by a restoring force that causes it to protrude into the opening of the casing, and is constituted so as to be capable of being made to withdraw upon being pressed upon by the rod portion of the multiconductor plug when the rod portion of the multiconductor plug is inserted into the opening.
